(19) United States
(12) Patent Application Publication
(10) Pub. No.: US 2019/0216584 A1
(43) Pub. Date: Jul. 18, 2019

(54) Light Curing Device With Control Circuit

(71) Applicant: Ivoclar Vivadent AG, Schaan (LI)

(72) Inventor: Dario Tommasini, Mastrils (CH)

(21) Appl. No.: 16/308,162

(22) PCT Filed: Jun. 2, 2017
(86) PCT No.: PCT/EP2017/063471

§ 371 Date: Dec. 7, 2018

(30) Foreign Application Priority Data
Jun. 17, 2016 (EP) 16174997.3

(51) Int. Cl. A61C 13/15; H05B 37/02

(52) U.S. Cl. CPC A61C 19/004; H05B 37/0227

(57) ABSTRACT

The invention relates to a light curing device comprising a control circuit by means of which said light curing device can be switched on and/or off, particularly from a stand-by mode into an operating mode and back again, and comprising a sensor for triggering switching on and/or switching off, characterised in that the sensor is designed as a capacitive proximity sensor (36) having a sensitivity of less than 1 pF, and that the control circuit (40) differentiates between the approach of a user's hand to the light curing device (10) and the approach of the light curing device to a base.

The invention relates to a light curing device, according to the Preamble of claim 1.

Light curing devices have been used for more than 30 years as hand-held devices in order to achieve light curing even in areas that are difficult to access, such as narrow areas in extracorporeal prostheses or mesial areas on the teeth of patients with dental restoration parts.

For this purpose, the light curing unit has a slim light guide rod, which is typically bent at the end and held in a housing. The housing contains a control circuit and an energy source for a light source of the light curing device. The housing is typically either rod-shaped or pistol-shaped or has a mixed form of these two forms.

The reason for this is the optimization of operability, since some dentists—or even dental technicians—prefer to hold the light curing devices in the form of a pistol for extracorporeal work, others in the form of a pencil, and still others like to grip over the corpus of the light curing device. A light curing device is typically operated in a program-controlled hardening cycle, wherein the user first selects the operating profile and then initiates the hardening cycle.

This eventually include a pre-hardening cycle including an eventually different emission spectrum of the emitted light.

As initialization of the curing device requires a few seconds and a corresponding start delay is unacceptable, the curing device is typically first switched on, before the actual operating cycle takes place. To switch on the curing light, a power button is typically used, which can be arranged at the transition between the handle and the main housing of the curing light, for example in the manner of a trigger for a pistol. However, the power button may also be located on the top of the curing device, especially for pen-shaped curing devices, and is typically arranged separately and independently from the power button for the respective program of the light curing device.

Nowadays, light curing devices often have a small display—regardless of the selected housing shape—on which the essential operating parameters are indicated and which is also intended to provide handling instructions.

However, there is still a need for optimization, especially among dentists with little affinity for technology. Typically, the light curing devices, if they are battery-powered, are charged on a base or base station. This is done via contacts which are embedded on the top of the base station and providing the power supply for corresponding counter contacts at the hand-held device.

It has already been suggested that removal of the handheld device from the charging station should be used as a signal for switching the curing device into the stand-by mode, and that return to the base station should be used as a signal for switching off.

However, a typical dentist is distracted from handling the light curing device while treating the patient, so he often would deposit the light curing device adjacent to the charging station.

As a result, either the battery will then permanently be discharged or the charger will automatically be switched off by itself after a certain time. In the first case, the battery will often be empty when the device is needed again, and in the second case it is not available before separately initiating and passing through the initialization cycle.

In order to minimize the time delay in these quite frequent cases, an attempt has been made to shorten the initialization cycle. For example, calibration steps are omitted, or they are only carried out every fifth time. This is also true when checking the system units for completeness and reliable functioning.

On the other hand, however, this is critical, because if, for example, the light curing device fails during an operating cycle, incomplete curing occurs, which is susceptible to risks of liability.

On the other hand, the invention object of the invention is to provide a light curing device in accordance with Preamble of claim 1, comprising long term and safe functioning, while at the same time also allowing unfailing operation.

According to the invention, this object will be achieved by the features of claim 1. Advantageous further embodiments will arise from the Subclaims.

According to the invention, it is provided for the light curing device to be switched on when approaching the user's hand. It is preferred for the user's hand to differ from the supporting base in terms of its capacity. This means that the light curing device is not switched on into the stand-by mode when the light curing device approaches said base, but when one hand approaches the light curing device.

In a preferred embodiment, the respective sensor is configured as a capacitive proximity sensor. It distinguishes between the capacity of a hand or finger of the user and the capacity of the surface. For example, the capacity of the supporting base can experimentally be determined and stored in the light curing device. A capacity change around the capacity of the supporting base is thus not used as a switch-on signal, whereas the switch-on process definitely consists of a hand's approach and the associated capacity change. Said change, for example, may be 5 Picofarad.

In a favorable embodiment it is provided for the capacitive proximity sensor to be covered by an active shield. In this way, parasitic capacitances and external interference can be avoided or their effect to the proximity sensor can be reduced.

While a grounded shield typically represents a parasitic capacitance that obscures the significance of the measured capacitive signal from the proximity sensor, the active shield can be controlled such that there is no voltage difference between the active shield and the capacitive proximity sensor. The shield electrode also shields the electrode of the proximity sensor from environmental influences.

A particularly beneficial effect of an active shield is the possibility of influencing the detection direction of the capacitive sensor. If the active shield is located below the electrode of the capacitive sensor, the capacitive sensor primarily detects the capacitance changes above the electrode.

If the active shield also extends slightly laterally around the sensor electrode, the focus is even stronger on the area directly above the electrode.

According to the invention, it is beneficial in this context to place the active shield below the sensor electrode, but in such that, in any case, the active shield is not larger than the electrode, but slightly narrower.

This solution has the effect that the angle of detection, for example, for a user's hand approaching, but also of another conductive object, is measured at an angle of 160 degrees, for example, i.e. almost everywhere.

The electrode preferably also extends over a substantial portion of the housing of the light curing device.

Another benefit of the active screen is the ability to reduce the effect of parasitic capacitance. The housing of the curing device typically contains conductive elements, such as the control circuit and conductor paths thereof and other cables, especially those connected to ground.

Between these electrical conductors and the sensor electrode there are typically several parasitic capacitances connected in parallel. The active shielding electrode arranged between them and the sensor electrode now enables both the sensor electrode and the shield electrode to switch off or minimize the parasitic capacitances, typically from 50 picofarads to 1-2 picofarads, when alternating voltage is uniformly applied.

Typically, the curing unit is placed on a supporting base when not in use. Depending on the shape, deposition of the curing device is done on the bottom side or usually laterally, at least if there is a light guide rod bent at the end, which then prevents the curing device to be placed on the bottom side, if the light curing device is not inserted into the base station.

In order to detect a tray to be placed on a surface such as a table, a capacitive proximity sensor can also be used laterally, to detect, for example, approach of a metal table to the light curing device when being placed. Herein, differential recording is suitably done, i.e. change in capacity of the sensor electrode and the side electrode and their relationship to each other, to determine whether the surface is approaching the curing device or a user's hand.

Herein, another approach in turn is the corresponding use of the active screen. The Focus of detection can be adjusted by configuring the active screen such that only approaching from above i.e. from the top of the curing device, is detected as being significant.

Placing the light curing device with its ‘back’ on the supporting support becomes not possible at all, if the light curing device is given a typical pleasant shape with a rounded upper side, which would cause the light curing device to tilt to the side when the user tries to deposit the device on the top side.

In this way it is also possible to distinguish between the approach of the support and the approach of the user's hand.

In another possible configuration, it is provided for an additional electrode to be placed on the bottom side of the curing device to detect the approach of the base station. This is advantageous if the base station is configured as a storage tray, i.e. without any charging function, whereas typically in a base station comprising electrical contact, the current flow during charging the accumulators of the light curing device can be easily detected.

It is to be understood that the additional electrodes can also be equipped with an active shield in a manner known per se, with the previously described and favorable effects of avoiding parasitic capacitances on the one hand and realizing focusing in the desired manner on the other.

If in the context of this application, a ‘sensor-electrode’ or the like is meant, it is understood that a suitable electrode arrangement actually meant. Strictly speaking, a capacitive sensor electrode typically consists of a plurality of individual electrodes, for example two individual electrodes, between which an electric field is built up that is influenced by the effect of a conductor, such as a human body part. Thus, the capacitive electrode typically detects a disturbance of the electrical field lines of the electrode arrangement.

It is to be understood that this is true both for the—primary—sensor electrode for detecting the user's hand and the secondary or additional electrodes for detecting the supporting base.

In a beneficial configuration of the invention, it is provided for the sensor electrode to be part of a capacitive bridge circuit. In a manner known per se, it can be deduced from a bridge imbalance that change of capacitance has occurred at the respective electrode.

Further advantages, details and features result from the following description of several examples of the invention, while reference is made to the drawings, wherein:

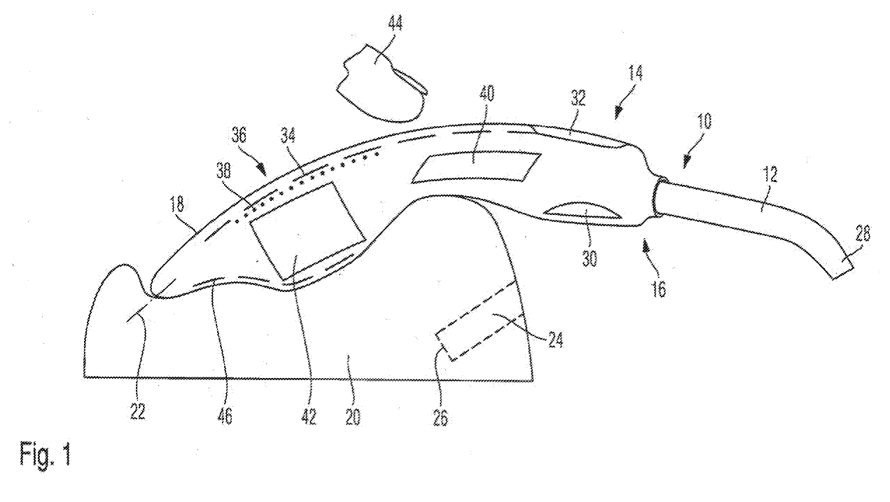

FIG. 1 is a schematic view of a light curing device according to the invention, taken at a base station for the light curing device;

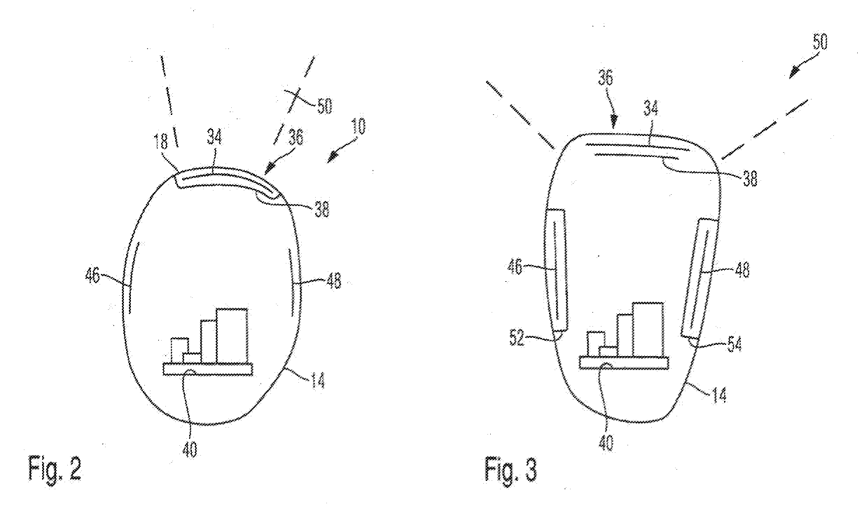

FIG. 2 is a schematic cross-sectional view through another embodiment of a light curing device according to the invention;

FIG. 3 is a schematic cross-sectional view through a third embodiment of a light curing device according to the invention.

The light curing device 10 schematically shown in FIG. 1 has a light guide rod 12 and a housing 14. The light guide rod 12 is pluggably attached to the front end 16 of the housing and is downwardly bent in a manner known per se at an angle of approximately 45 degrees.

The light curing unit 10 has a pleasant and at the same time user-friendly basic design. This includes a spherical or rounded upper wall 18 of the housing 14. In the position shown, the curing unit 10 is supported and accommodated in a base station 20. The base station 20 is configured as a charging tray and comprises plug-in contacts 22 which are schematically shown, and which charge accumulators in the light curing unit 10 when located into the base station 20.

The base station 20, on its upper side, is shell-shaped, so that an elongated recess to a large extent accommodates the housing 14 of the light curing device. In addition, the base station 20 has an opening 24 on its front side. The opening 24 is equipped with a calibration sensor 26, which enables calibration of the light curing device 10.

To achieve this, the light curing device 20 is inserted into the opening 22 with the front end 28 of the light guide rod 12, and the light curing device is switched on. A calibration program then traces the calibration in a manner known per se.

The opening 24 is also open towards the bottom, thus essentially is slit-shaped, which prevents the calibration sensor from becoming contaminated, as could be the case with a blind hole opening. In addition, the calibration sensor 26 can easily be cleaned from below, if necessary.

The curing unit 10 also comprises a switch 30 and a display 32 on the housing 14. The housing 14 is essentially pencil-shaped, but approximating to the pistol shape, and typically may be held with one hand gripping across the housing 14 from above. The switch 30 or release button obliquely attached to the bottom side may subsequently be operated with the user's index finger, for example, while the display 32 is clearly visible in the user's field of vision.

The housing 14 is made of electrically insulating material such as for example ABS or any other suitable plastic material. According to the invention, an electrode 34 is attached to the upper wall, which rests against the upper wall 18 and extending from a rear area to the display or extends to be just in front of the display. The electrode 34 extends on the inside of the housing, either as a vapor-deposited layer or as a metallic surface. The electrode 34 simultaneously serves as a proximity sensor 36. It is shielded by an active shield 38, which also extends along the upper wall 18, but below the electrode 34.

A control circuit 40 is located in the middle of the housing 14, at least significantly in front of accumulators 42, which, due to its weight, form a counterweight when handling the light curing device 14, offering ergonomic advantages. When a user's finger 44 approaches, change in capacitance around the electrode 34 and thus the proximity sensor 36 is detected. This change of capacitance causes the control circuit 40 to switch on the light curing device, preferably into the stand-by mode, where it is ready to perform a curing cycle when the switch 30 is actuated.

In the embodiment example shown, an additional electrode 46 is arranged on the bottom of the housing 14 to detect whether the light curing device 10 is placed in the base station 20 or, for example, on a table. If the base station 20 is equipped with plug contacts 22, deposition in the base station as a charging tray can also be detected electrically.

According to FIG. 2, another embodiment of a light curing device 10 according to the invention is shown in a cross sectional view. Herein as in the other figures, equal reference numbers refer to equal parts. In the embodiment shown according to FIG. 2, two additional electrodes 46 and 48 are laterally provided. The main electrode 34 is arranged on top, on the upper wall 18 of the housing 14. It is inwardly covered by an active screen 38. In this configuration, the active shield 38 essentially extends U-shaped around the electrode 34. This results in a narrower detection angle 50, such that the sensor 36 only becomes active and indicates the hand of a user as soon as it approaches from above.

Due to its shape, which, in cross-section, is highly oval, the light curing device would roll to the side when placed on a conductive surface such as a table. In this case, the table approaches either the additional electrode 46 or the additional electrode 48.

This is detected by the associated control circuit 40, so that the control circuit does not inadvertently switch the light curing unit into the stand-by mode when approaching the table.

Another embodiment is shown in FIG. 3. Herein, the cross-section of the housing is slightly more V-shaped, but essentially is also highly oval. In this embodiment, the additional electrodes 46 and 48 are shielded by additional active shields 52 and 54, so that the sensitivity of the additional electrodes 46 and 48 is also very high.

According to the embodiment of FIG. 3, the active shield 38 for the main electrode 34 is slightly shortened. As a result, the active detection range 50 has a wider detection angle, so that even a hand approaching from the side switches on the standby mode.

It is to be understood that the switching function in accordance with the invention can also be used for other control options. For example, a plurality of electrodes may also be arranged as being distributed on the housing 14, and different operating modes of the device can be switched on depending on the order of operation.

1. A light curing device comprising
a control circuit configured to switch on and switch off the light curing device and
a sensor for initiating switching on and/or switching off the light curing device,
wherein the sensor is configured as a capacitive proximity sensor (36) having a sensitivity of less than 1 pF, and
wherein the control circuit (40) distinguishes between an approach of a user's hand to the light curing device (10) and an approach of the light curing device to a supporting surface.

2. The light curing device according to claim 1,
wherein the control circuit (40) generates an electric field around the light curing device (10).

3. The light curing device according to claim 1,
wherein the sensor (36) has an initial capacitance in the base of the light curing device, and
wherein the control circuit detects a capacitance change with respect to this initial capacitance in the range of less than 1 pF.

4. The light curing device according to claim 1,
wherein the sensor (36) is part of a capacitive bridge circuit and
the control circuit (40) detects an imbalance of the bridge.

5. The light-curing device according to claim 4,
wherein the sensor (36) and other parts of the bridge circuit are each connected to an electrode (34) or comprise an electrode which, as viewed from the light-curing device (10), faces outwardly from the light-curing device.

6. The light-curing device according to claim 1,
wherein the control circuit (40) comprises a switching threshold, from where a capacitance change is determined as being an approach of a user, and from where the light-curing device (10) switches into the operating mode.

7. The light-curing device according to claim 1,
wherein the sensor switches on the light-curing device by approaching a predetermined distance value from the light-curing device to a hand, when the capacitance of surroundings of the light-curing device (10) changes.

8. The light-curing device according to claim 1,
wherein the light-curing device (10) is connected to the electrode (34) of the sensor (36) via a shielded line.

9. The light-curing device according to claim 8,
wherein the shielded line is operated according to the principle of an active shield which compensates for environmental influences.

10. The light-curing device according to claim 1,
wherein the electrode (34) is part of a capacitance bridge and each part is connected to the control circuit (40) via a shielded line.

11. The light-curing device according to claim 1,
wherein a first capacitive proximity sensor (36) is arranged on, or within an upper face or wall (18) of the light-curing device (10).

12. The light curing device according to claim 1,
wherein an auxiliary proximity sensor (46,48) is arranged on a bottom side of the light curing device (10) and is in communication with the control circuit (40), and
wherein the control circuit (40) switches off the light curing device when the auxiliary proximity sensor (electrodes 46 and 48) signals the proximity of the supporting base.

13. The light-curing device according to claim 1,
wherein the capacitive proximity sensor is covered by an active shield (38) which reduces environmental influences affecting the capacitive proximity sensor (36).

14. The light curing device according to claim 1,
wherein the light curing device comprises a plurality of electrodes and the control circuit (40) of the light curing device (10) determines the respective operating mode as a function of the order in which signals are detected at the electrodes of the capacitive sensor.

15. The light curing device according to claim 1,
wherein the light curing device can be switched on and/or off from a standby mode to an operating mode and vice versa.

16. The light curing device according to claim 2,
wherein the electric field is an alternating electric field.

17. The light curing device according to claim 3,
wherein the capacitance change with respect to the initial capacitance is in the range of less than 100 fF.

18. The light-curing device according to claim 7,
wherein the predetermined distance value is in the range of about 5 to about 10 cm.

19. The light-curing device according to claim 10,
wherein the shielded line is an actively shielded line.
